(19) United States
(12) Patent Application Publication
(10) Pub. No.: US 2010/0216083 A1
(43) Pub. Date: Aug. 26, 2010

(54) Device for Bonding Orthodontic Brackets on Teeth

(75) Inventor: Johannes Petrus Michael Grobbee, Oosterbeek (NL)

Correspondence Address: GLENN L. WEBB;GLENN L. WEBB P.C., P.O BOX 3788, DURANGO, CO, 81302, US

(73) Assignee: GROTECH B.V., Oosterbeek (NL)

(21) Appl. No.: 12/097,043

(22) PCT Filed: Dec. 12, 2006
(86) PCT No.: PCT/NL2006/000637

§ 371 Date: Jun. 11, 2008

(30) Foreign Application Priority Data
Dec. 12, 2005 (NL) PCT/NL2005/000851

(51) Int. Cl. A61C 7/02; G06F 17/50

(52) U.S. Cl. 433/3; 700/98; 700/117

(57) ABSTRACT

A bonding device for bonding orthodontic brackets on teeth. The device includes a positioning element having one or more bracket holders mounted to be movable relative to the positioning element. The positioning element fits on a set of teeth so that the bracket holders may be moved into a desired position on the teeth for positioning and bonding brackets in place on the teeth.

The invention relates to a bonding device for bonding orthodontic brackets on teeth.

Such bonding devices are known from practice and have been developed to ease the bonding process of brackets on teeth. A common bonding process of brackets to teeth comprises manually locating and adhering the brackets on the teeth. An orthodontist determines the bonding location of every single bracket and bonds it with a bonding cement on said location on the tooth. This is a precise and work intensive operation. It is important that the brackets are located on the best possible location in order to guide the teeth to the new corrected position. If the brackets are placed in a wrong angle or on the wrong place on the tooth surface, the orthodontist has to manipulate the arch wire that will be placed in the cavities in the brackets to get an optimal correction of the position of the teeth, e.g. to overcome the malocclusion.

In order to ease the orthodontic treatment of the orthodontist, it is known to use a bonding tray. In this known method, a plaster or plastic model of the teeth is provided on which the orthodontist places the brackets. The total of the plaster model and the brackets is covered with a silicone layer to form an inner tray to fix the brackets in the way the orthodontist wants the brackets to be placed on the teeth. An outer tray of a firmer material is formed to fit on the inner silicone tray. The tray including the brackets is removed from the model. Adhesive or bonding cement is put on top of the bracket sides that have to engage on the teeth surfaces. Then the tray is put on the set of teeth of a patient till the adhesive has hardened. After that, the tray is removed from the teeth, leaving the brackets on the teeth.

A disadvantage of this indirect bonding tray is that when the tray is put onto the patient's set of teeth, the tray undergoes a sliding movement along the teeth. Consequently, bonding cement can be slid off the bracket having a negative influence on the adhesive characteristics of the bracket. The bonding cement remains at the incisal/occlusal side of the teeth and close around the bracket. This bonding cement has to be removed after the bonding process of the bracket. This takes an additional operation that lengthens the bonding procedure.

US 2003/0224310 discloses a placement jig for locating an othodontic appliance on a tooth with a cavity formed in a jig body and conforming to the contour of an occlusal portion of a tooth crown, which cavity is coated with a realeasable adhesive to hold the jig to the tooth as the bracket is bonded to the tooth. A connecting structure or peg is fixed to the jig body and has a spring metal tip that frictionally fits into a hole in the bracket. The peg is oriented in the occlusal-gingival direction so that its tip slides out of the hole in the bracket when the jig is moved occlusally from the tooth to remove the jig after the bracket has been bonded. When mounted on the jig body, the peg is not moveable relative to the jig body. Consequently, when placing the jig body with the peg carrying the bracket connected thereon onto the tooth, there will occur a sliding movement of the bracket along the tooth surface leading to the problems described above.

US 2003/0003415 discloses an apparatus for precisely locating an orthodontic bracket at a predetermined position on a surface of a tooth. The apparatus has a suspension body, a ring, and a molding spacer. When the bracket is connected to the suspension body with the aid of the ring, no movement of the bracket relative to the suspension body is possible. Consequently, when placing the suspension body with the bracket mounted thereon onto the tooth, there will occur a sliding movement of the bracket along the tooth surface leading to the problems described above.

JP 2002-102256 A discloses bonding device having a tray with a configuration corresponding to the patient's tooth or teeth. The tray carries a support cylinder with a rectangular central bore. A sliding arm with a rectangular cross section is slidably mounted in the support cylinder. A bracket to be placed on a tooth is releaseably mounted on the sliding arm. After placement of the tray on the tooth, the bracket is moved towards the tooth face by sliding the sliding arm through the support cylinder. The sliding arm has two indentations in which a stopper member can engage to provide two stable positions for the sliding arm. Although the apparatus according to the Japanese publication has the advantage that the brackets do not make sliding movement along the teeth face, the Japanese apparatus has other disadvantages.

First of all, the sliding arm does not provide a stable carrier for the bracket. Consequently, the positioning of the bracket on the tooth face by means of the sliding arm is not accurate.

Secondly, the range of freedom to vary the rotational position of the bracket relative to the tooth is limited because of the long arm 27d and the fixed cross 27b at the end of the arm 27d. The sliding arm has a standard configuration which is not intended to be adapted to the requirements of the teeth to be repositioned. The only portion of the known apparatus of which the configuration is adapted to the teeth of the patient is the tray 21.

Thirdly, the known apparatus is complicated, difficult to manufacture and expensive because of the large number of separate parts, i.e. a tray 21, a sliding arm 27, a support cylinder 23 and a stopper member 41 for each tooth.

Fourthly, the known apparatus requires a fairly large space to be placed. The height of the tray with the arm is large and the space needed in front of the teeth is considerable.

The object of the invention is to provide a bonding device without the above drawbacks.

It is therefore an object of the invention to provide a device for bonding of orthodontic brackets that enables precise and fast bonding of the brackets, and which is easy to manufacture.

In order to achieve this object, the bonding device according to the invention comprises positioning element provided with at least one bracket holder with a bracket releaseably mountable thereon, the positioning element adapted to fit on a set of teeth in a determined position, wherein the at least one bracket holder is adapted to move relative to the positioning element, the bracket holder being hingedly connected to the positioning element. The bracket can be placed easily and quickly on the exact right location. After placing the positioning element, which only fits in one way on the patient's teeth, each individual bracket holder holding a bracket can be moved in one way towards the tooth surface by hinging the bracket holder from an initial position to a bonding position, in which bonding position the bracket, or at least the bonding cement on the bracket abuts the tooth face. Therefore, the bonding process itself is very easy. Because of the fact that the individual bracket holders are in a first position when the positioning element is placed on the tooth or teeth, much space is available to clean and dry the surface of the tooth and to apply bonding cement to the bracket. In the known Japanese device the space is occupied by the slider arm and the bracket mounted thereon. Consequently, the cleaning and drying of the tooth surface as well as the application of bonding cement on the bracket in the Japanese device is cumbersome. Further, when handling operations are performed for bonding one bracket, the neighbouring bracket holders can be kept in the initial position, thus providing sufficient space for performing the handling operations for bonding said one bracket. Another advantage of the device according to the invention is that the height of the device is small when the bracket holders are in the initial position, at least much smaller than with the devices known from the publications described above. Because of this limited height, the insertion of the device into the mouth of the patient is easy, which is a very important advantage. Also from a manufacturing point of view it is advantageous to have more limited height. When the device is manufactured by milling, a milling device which is controllable along only 3 axis is able to do the job because, in the initial position of the bracket holders, the structure on the bracket holders with which the brackets are mounted on the bracket holders are in the same plane as the tooth cavities or fixture recesses in the positioning element. When the device is manufactured by a layer manufacturing technique, a limited height leads to a shorter manufacturing time.

It is noted that by teeth are meant the anterior teeth (the front teeth), the pre-molars (in between the anterior teeth and the molars) and the molars (including wisdom teeth).

Due to the hinge movement of the bracket holders relative to the positioning element, the relative hinge movement is such that, in use, no sliding movement of a bracket mounted in said bracket holder along a corresponding tooth occurs.

The bonding device according to the invention provides a clean way of bonding the brackets. The bonding adhesive cannot not slide off the bracket and consequently no unwanted bonding adhesive remains on the teeth surfaces around the bracket or on the incisal/occlusal side of the teeth like with the known trays. This saves cleaning time and costs. Also the bonding device according to the invention does not have decreasing adhesion characteristics because of partially slid off adhesive or bonding cement, therefore the adhesion characteristics of the brackets are better than when using known bonding devices.

An orthodontist or a less skilled person can move the bracket holder with only one finger, without having to be very precise or taking the predetermined bonding position into account. After all, the bracket is mounted on the bracket holder on a position with a fixed relation to the predetermined bonding position and when the bracket holder is moved, the bracket automatically will get to the predetermined bonding position on the tooth.

Compared to known trays wherein the brackets are fixedly mounted, the bracket holders of the bonding device according to the invention are easier to remove. Only the individual bracket holders have to be taken of the bracket by a reversed movement as used for bonding. No more tray parts will be stuck between bracket cavities or other places, which takes in the known method a lot of time of the orthodontist to remove it. Another advantage is that the bracket holders are spaced apart, enabling light used for hardening the bonding cement or adhesive to easily reach said cement or adhesive.

In another advantageous embodiment the positioning element is provided with fixture recesses for receiving teeth.

Preferably, the fixture recesses are adapted to fit on at least one of the surfaces of the teeth being occlusal/incisal surfaces, lingual surfaces or buccal/labial surfaces of the teeth or a combination of said surfaces.

The surfaces on which the fixture recesses have to fit are chosen by the orthodontist on basis of the needed corrections of the teeth. According to the teeth that have to be provided with a bracket and according to the location of said brackets, the best surfaces to fit the positioning element on are selected and the fixture recesses are adapted to fit on those surfaces.

The positioning element can only be mounted on the patient's teeth in one way and the bracket holders preferably only hinge around one fixed hinge axis, therefore small displacements of the brackets in relation to the predetermined bracket bonding position are not likely to occur. For instance, with the know trays alignment took place with regard to the incisal edges of the teeth. The orthodontist had to precisely position the tray according to said edges to overcome positioning deficiencies.

In further elaboration of the invention, the device is adapted for bonding the brackets to teeth in a lower jaw, to teeth in an upper jaw, or for bonding the brackets to teeth both in said lower jaw and said upper jaw at the same time. The bonding device can be adapted according to the teeth that have to be provided with brackets. In case that only the teeth or some of the teeth in the lower jaw have to be corrected because of malocclusion, a positioning element is provided with fixture recesses in the surface facing the occlusal/incisal sides of the teeth in the lower jaw. When it concerns only teeth in the upper jaw, the fixture recesses are provided in the surface of the positioning element facing the teeth in the upper jaw. It is also possible to provide a positioning element with fixture recesses on both surfaces and bracket holders intended for cooperation with teeth in the upper jaw and at the same time having bracket holders intended for cooperation with teeth in the lower jaw to place brackets on said teeth. It is very favourable that in case of malocclusion of a patient's set of teeth, the positioning element is adaptable to each individual patient.

According to another advantageous embodiment of the invention, the at least one bracket holder is movable towards an outer surface of a tooth to bond the bracket on the buccal or labial surface of said tooth and/or towards an inner surface of the tooth to bond the bracket on the lingual surface of said tooth. Dependent on the kind of correction, each surface of the tooth can be reached to bond a bracket on. The bonding device is adaptable to provide the desired bracket holders. In some cases it is preferred that a bracket is placed on the lingual side of a tooth because that provides esthetical advantages and in some cases a better correction. With the bonding device according to the invention it is possible to bond a bracket on the buccal/labial surface of a tooth at the same time as bonding a bracket on the lingual surface of that same tooth.

In further elaboration of the invention a bracket mount is provided on the at least one bracket holder for releaseably mounting the bracket onto said bracket holder. It is very advantageous if each bracket mount is adapted to cooperate with an arch wire cavity in the bracket. The bracket mount on the bracket holder enables easy removal of the bracket holder when bonding of the bracket has already occurred. Adapting the bracket mount to the arch wire cavity in the bracket enables an easy connection between the bracket and said holder. Further, such a bracket mount intended for co-operation with the arch wire cavity provides a positively defined position of the bracket relative to the bracket holder. No additional fasting means are necessary because the bracket mount provides a clamping connection between the bracket holder and the bracket.

Because the removal of the brackets from the bracket holders is easy, the bonding device completely stays in tact after having used it. Therefore it is possible to reuse said bonding device for instance when one bracket incidentally falls off a tooth. That bracket has to be placed on the corresponding bracket holder, the positioning element has to be positioned on the teeth again and the bracket holder has to be moved to the tooth again.

Another advantage is that the arch wire can already be placed in the arch wire cavity before the bracket is placed on the tooth. Thus, the brackets already comprising the arch wire are placed on the teeth surfaces. For lingual placement this can be effective because the working space in between the teeth arch at the lingual side of the teeth is relatively small.

Each bracket mount comprises, according to another elaboration of the invention, a ridge that is receivable in the arch wire cavity for fixing the bracket in a direction parallel to a tooth axis extending from a root of a tooth to an incisal/occlusal edge of a tooth, said ridge comprising at least one end stop for fixing the bracket in a direction parallel to the arch wire cavity.

By providing a ridge with at least one end stop, the bracket is fixed in a direction parallel to the tooth axis and a direction parallel to the arch wire cavity. This means that the bracket cannot move relative to the bracket holder, thereby increasing the accuracy of the bracket bonding position. Furthermore, the bracket mounts are adaptable to desired bonding positions and angels. For example, to place a bracket in an angle to a tooth surface, the bonding means only have to be provided in an angle on the positioning element.

In further elaboration of the invention, the device further comprises a fixation element for fixating the bracket holders, after bringing the bracket holders with the brackets towards the tooth surface, until the bonding cement is hardened. Preferably, this fixation element is one of a fixation ring, a spring, a rubber, or a band. Also any other kind of fixation element can be provided, as long as the bracket holders with the brackets are fixated till the bonding cement is hardened. A fixation element is very advantageous, because the at least one bracket holder can be released by the orthodontist after bonding. It is not necessary to hold the bracket holder by hand for the time the bonding cement takes to harden.

According to another embodiment of the invention the predetermined bonding position is determined on basis of a virtual model and virtual setup of the set of teeth.

This is very advantageous because no more positioning on a plaster model is needed. A virtual model can be created in a more effective and efficient way. Furthermore, it is easier to transfer data when the model is in a digital format. To create a virtual setup a digital model of the teeth is provided. The orthodontist virtually moves the teeth into a desired position, i.e. the new position of the teeth after correction. The orthodontist then decides where the brackets have to be placed for the teeth to reach the desired position (i.e. the virtual setup). The teeth in the virtual model are then returned in the initial position, i.e. the position of the patient's teeth before correction, the brackets being in the predetermined bonding positions.

In further elaboration of the invention, dimensions of the positioning element, positions and dimensions of the fixture recesses, the bracket holders and/or the bracket mount are dependent on the data derived from the virtual model and virtual setup. The virtual setup and the virtual model provide a model of the teeth comprising the brackets on the predetermined bonding positions. That model is converted into a set of data that is used to determine the dimensions of the positioning element, the position and dimensions of the fixture recesses, the dimensions and positions of the bracket holders on the positioning element and the dimensions and positions of the bracket mounts on the bracket holders. The entire bonding device is constructed according to the data from the virtual model and virtual setup. It is clear that each bonding device is custom made for each patient. But due to the virtual model and virtual setup the construction is automated and takes less steps than when using the known way of constructing the known bonding devices.

Preferably, the virtual model is a 3-dimensional image of a converted negative dental impression. When the virtual model is made of a converted negative dental impression, the construction is even faster, because the step of making a plaster model is not necessary. The orthodontist makes a dental impression in alginate, or silicone, polyether of hydrocolloid dental impression material. That negative impression is scanned, for instance with a CT-scanner, and the negative impression is converted into a positive model.

The virtual model also can be a 3-dimensional image based on an inter-oral digital scan or on a clinical CT-scan. Furthermore, it is also possible to base the virtual model on a scan of a plaster of plastic model of the patient's teeth.

According to an advantageous embodiment of the invention, the device is manufactured with aid of milling or layer manufacturing. The data that are derived from the virtual setup and virtual model can be send to a manufacturing device that can manufacture the bonding device according to the features determined by the orthodontist. For example with the aid of milling, the bonding device can be made out of a plastic, by, for instance, milling the fixture recesses and the bracket mount on one surface of the positioning element and by milling the film hinges at the other surface of the positioning element. Milling is relatively cheap, quick and easy to program. Another way of manufacturing the bonding device is with aid of layer manufacturing technique.

In an advantageous embodiment of the invention, the bracket holder may be provided with an abutment element for defining an end position of the bracket holder in which the bracket holder has to be positioned for positioning the bracket in the desired position relative to the respective tooth. The abutment member can abut against the tooth or against the positioning element. Especially when the abutment member abuts against the tooth in the end position a very accurate positioning of the bracket holder, and consequently of the bracket, relative to the tooth is possible. Consequently, the distance between the bracket and the tooth and therewith the thickness of the layer of bonding material can be determined very accurately.

In another advantageous embodiment of the invention, the bracket holder has two stable positions relative to the positioning element, wherein one of the stable positions is an end position in which the bracket holder has to be positioned for positioning the bracket in the desired position relative to the respective tooth.

The advantage obtained with these two last embodiments is that the bracket can be kept at a small distance from the tooth surface so that direct contact between the bracket and the tooth surface is prevented and it is assured that under the entire bracket a bonding layer is present. This is important to obtain a good bonding between the bracket and the tooth surface.

With layer manufacturing techniques it is now possible to form the entire device, i.e. positioning element with bracket holders simultaneously. The bracket holders can be provided with a real hinge shaft which is mounted in a hinge shaft mounting. The shaft can be given a non-circular cross section, e.g. a square cross section with rounded edges while the hinge shaft mounting in the positioning element can have a non-circular, e.g. square cross section with a slightly larger size, so that the hinge shaft can assume at least two stable positions, i.e. a start position and an end position. The advantage of a bonding device in which the bracket holders have two stable positions is that no special measures have to be taken to keep the bracket holders in the end position. Once a bracket holder has assumed the stable end position it will stay there until the orthodontist or his assistant has verified that the bonding material is hardened and the bracket is fixed on the tooth. After that, the bracket can be disconnected from the bracket holder and the bracket holder can be brought back into the start position.

In the embodiment with the hinge shaft having the two stable positions and which has been made with layer manufacturing techniques, the space around the hinge shaft in the hinge shaft mounting can be filled during the layer manufacturing process with a support material which is wax like. The support material removes undesired play between the hinge shaft and the hinge shaft mounting. With the modern layer manufacturing techniques the entire device can be made in 2.5 minutes.

It is of great advantage that the bonding device can be manufactured without any assembling of separate parts being necessary. Both when using a layer manufacturing technique and when using milling, the hinge connection between the bracket holder and the positioning element can be an integral part of the device. This makes the device less costly than e.g. the Japanese apparatus which consists of several separate parts which have to be assembled to form the device.

The invention further relates to a method for manufacturing a bonding device according to any of the preceding claims, comprising a positioning element with at least one bracket holder with a bracket releaseably mountable thereon, the bracket holder being hingedly connected to the positioning element, the method comprising the steps of:
providing a digital model of a set of teeth
determining a bonding position on a tooth surface of the at least one bracket
converting the bracket bonding position into manufacturing data
operating manufacturing equipment according to the manufacturing data to manufacture the bonding device having a positioning element and at least one bracket holder movable relative to the positioning element.

This method has the advantage that the entire device is manufactured without any assembling operations of separate parts being necessary.

The invention further relates to a method for bonding orthodontic brackets on teeth, the method comprising:
providing a virtual model of a patient's teeth
providing a bonding device based on said model comprising a positioning element and at least one bracket holder movable relative to the positioning element, the bracket holder being hingedly connected to the positioning element
mounting a bracket releaseably on the at least one bracket holder
bringing bonding adhesive on a tooth side of said bracket
placing the bonding device in the patient's oral cavity in a determined position by means of the positioning element
moving the at least one bracket holder towards a tooth surface to bring said bracket in a predetermined bonding position, wherein moving the bracket holder towards a tooth surface comprises hinging the bracket holder around a hinge axis towards the tooth surface
pushing the at least one bracket holder with the bracket against said tooth, the bonding adhesive contacting the tooth surface.

These methods provide similar advantages as the bonding device mentioned before.

Further advantageous embodiments of the invention are described in the dependent claims.

The invention will be further elucidated by means of exemplary embodiments with reference to the accompanying drawings in which:

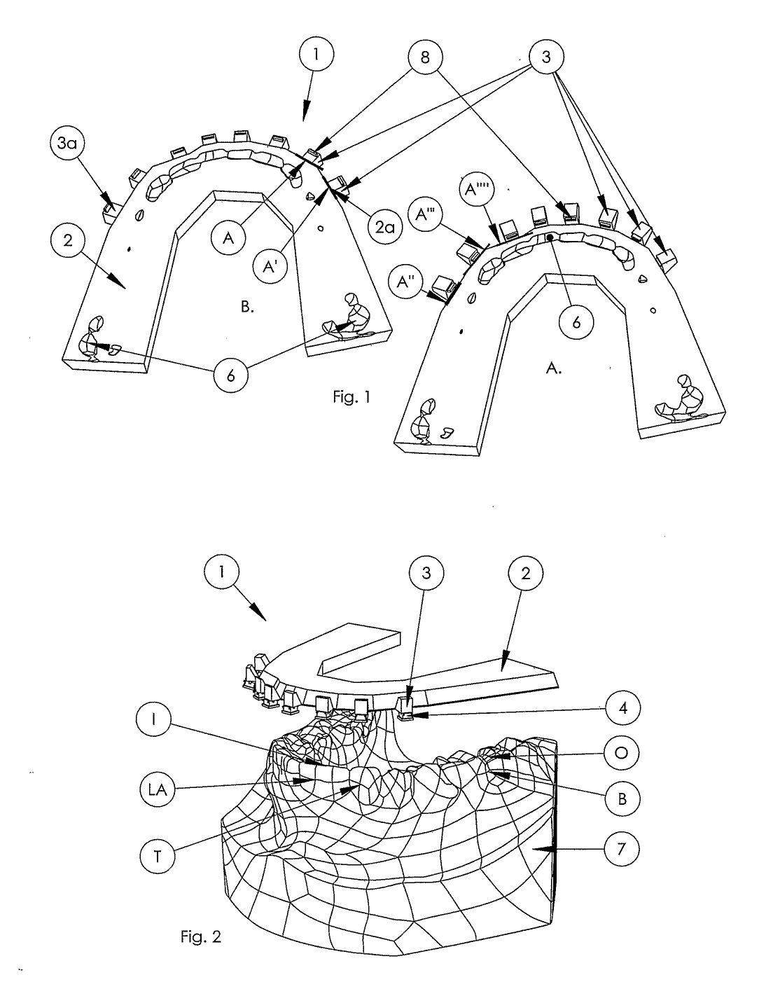

FIG. 1 shows a perspective view of the bonding device;

FIG. 2 shows another perspective view of the bonding device;

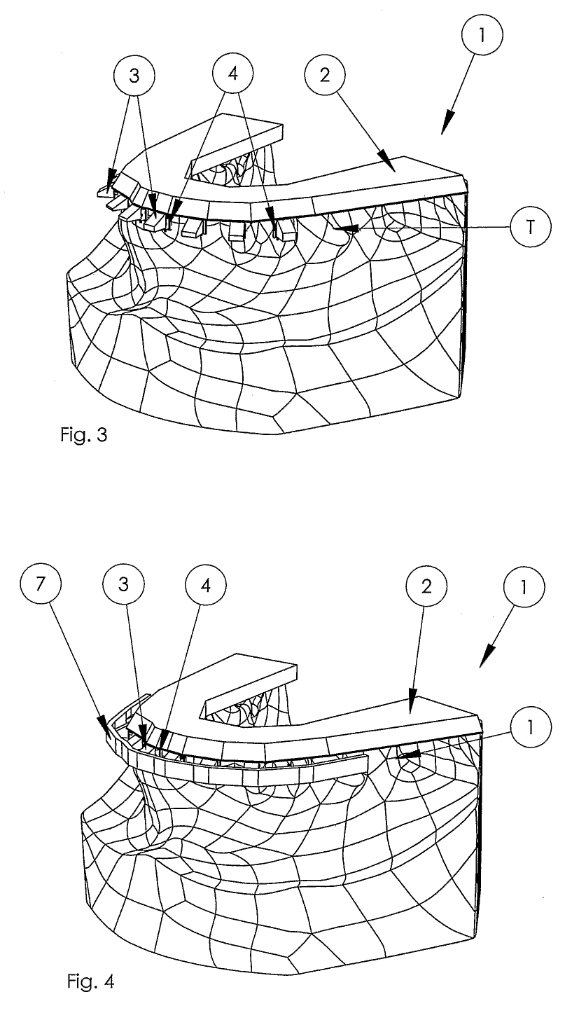

FIG. 3 shows a perspective view of the bonding device on a set of teeth;

FIG. 4 shows a similar perspective view as FIG. 3;

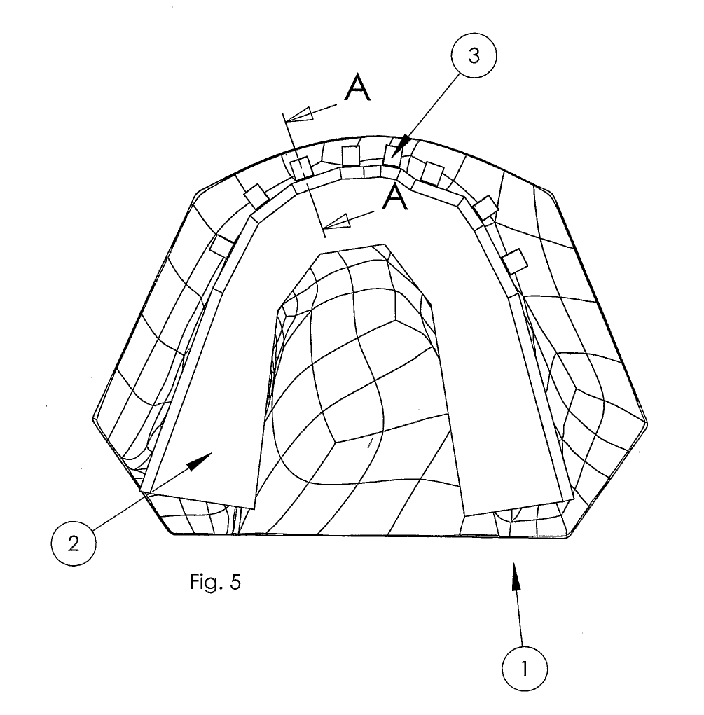

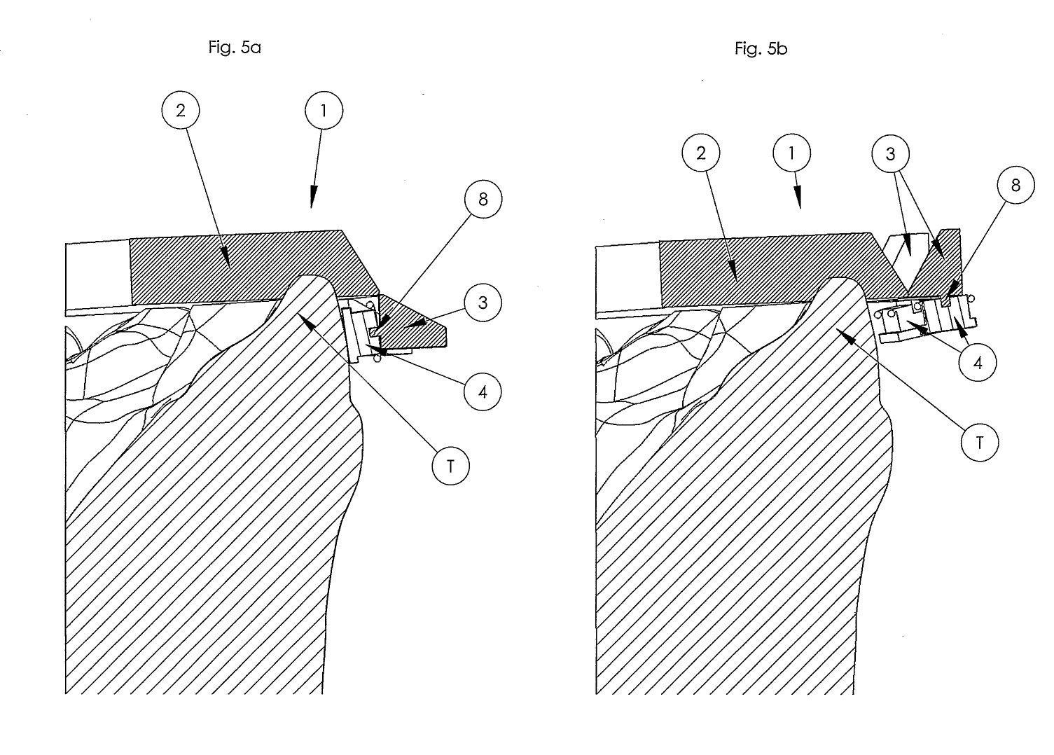

FIG. 5 shows a top view of the bonding device and FIGS. 5a and 5b are two cross sections;

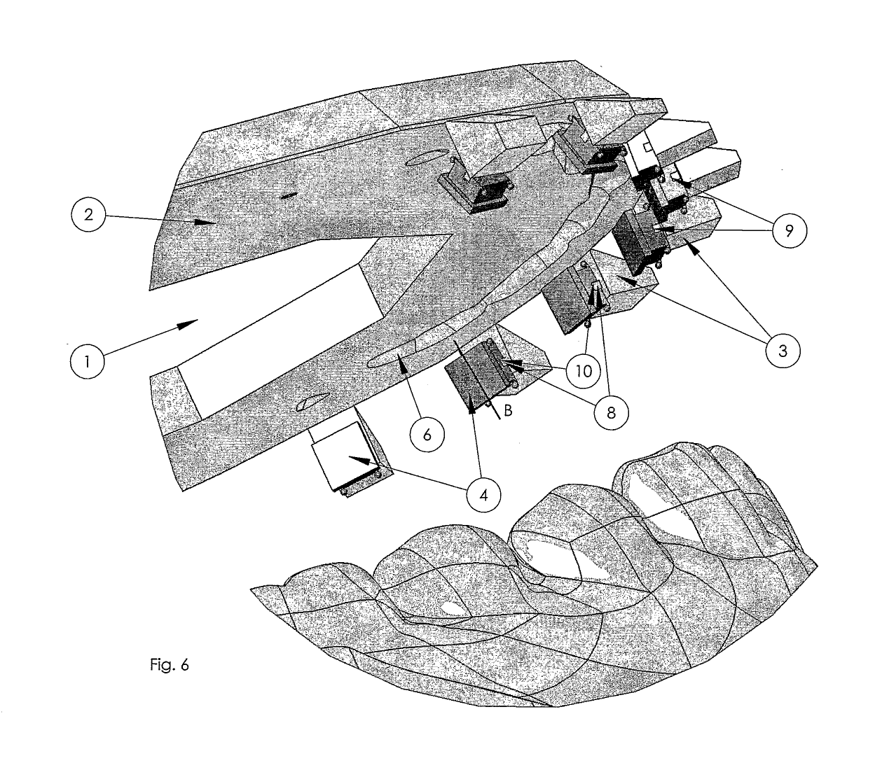

FIG. 6 shows perspective view of a detail of the bonding device;

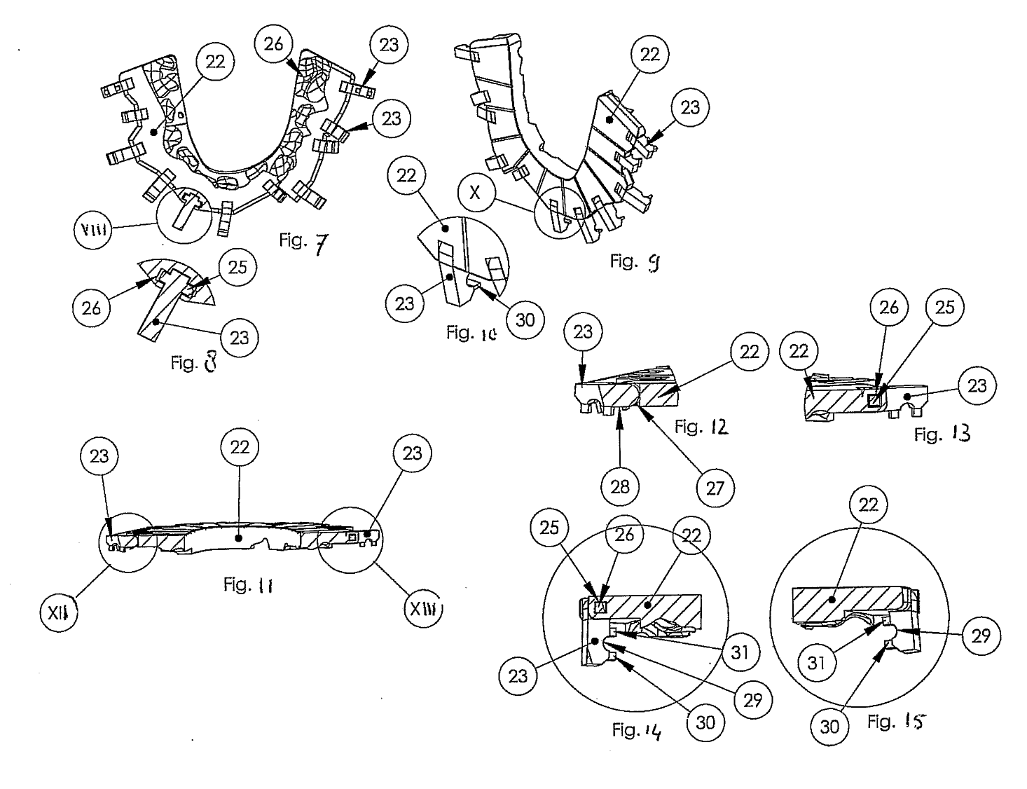

FIG. 7 shows a bottom view of another embodiment of the bonding device;

FIG. 8 shows a detail VIII from FIG. 7;

FIG. 9 shows a perspective top view of the embodiment of FIG. 7;

FIG. 10 shows a detail X from FIG. 9;

FIG. 11 shows two cross sections of the embodiment of FIG. 9;

FIG. 12 shows detail XII from FIG. 11;

FIG. 13 shows detail XIII from FIG. 11;

FIG. 14 shows a similar detail as in FIG. 12 in which the bracket holder is in the end position;

FIG. 15 shows a similar detail as in FIG. 13 in which the bracket holder is in the end position; and

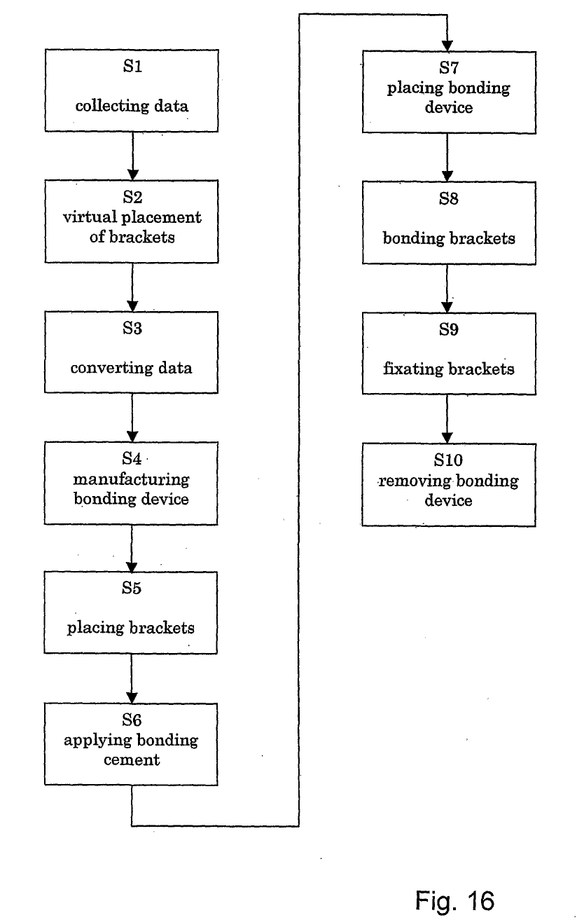

FIG. 16 shows a diagram of the bonding method according to the invention.

FIG. 1 shows a bonding device 1 for bonding orthodontic brackets on teeth. The bonding device 1 comprises a positioning element 2 provided with bracket holders 3. The bracket holders 3 comprise brackets 4 (see FIG. 2) releaseably mounted thereon. The bracket holders 3 are hingedly connected to the positioning element 2, preferably by a film hinge 2a. The bracket holders 3 hinge around a hinge axis A, which axis is a different axis (A, A′, A″ etc.) for each bracket holder 3 provided. By this hinge connection, the bracket holder 3 is adapted to move towards a position adjacent to a tooth surface 5 (see FIG. 2) to bring said bracket 4 in a predetermined bonding position in which it abuts said tooth.

The predetermined bonding position is determined on basis of a virtual model and virtual setup of the set of teeth. To manufacture a bonding device 1, a virtual model of the patient's set of teeth is made. First a dental impression of the teeth is made with aid of for instance a silicone, alginate, polyether or hydrocolloid dental impression material. That negative impression is scanned by for instance a CT-scanner. A set of data is gathered and is converted into a positive virtual model. It should be noted that the virtual model can also be based on an inter-oral digital scan of the teeth in the mouth or on a clinical CT-scan. It is also possible to scan a plaster or plastic pour-up model of the teeth to obtain a set of data. The orthodontist moves the virtual teeth to make a virtual setup and then determines the predetermined bonding position of each bracket to be bonded. Then the teeth are returned to their initial position and data based on the virtual setup are converted into manufacturing data. On basis of these manufacturing data, a manufacturing device is controlled. This can for instance be a milling apparatus or a layer manufacturing technique apparatus. In case of milling, the device is milled on two sides. On a first side to create the fixture recesses 6 and the bracket mounts 8, and on a second side to create the film hinge 2a. The manufacturing data comprises dimensions of the positioning element 2, positions and dimensions of the fixture recesses 6, the bracket holders 3 and/or the bracket mounts 8. For example the location of the bracket holders 3 relative to the positioning element 2, the length of the bracket holders 3 according to the length of the teeth and the location of the bracket mounts 8 amongst others determine the predetermined bonding positions of the brackets 4.

The positioning element 2 is provided with fixture recesses 6 for receiving teeth T. The fixture recesses 6 are adapted to fit on the surfaces of the teeth T. These surfaces can be occlusal (O)/incisal (I) surfaces (the chewing area's of the teeth), lingual surfaces (the surfaces of the teeth facing the tongue), or buccal (Bu)/labial (La) surfaces (the surfaces facing the cheek/lips). In FIG. 1, the positioning element 2 comprises fixture recesses 6 that fit on the occlusal (O)/incisal (I) surfaces of the teeth. The bracket holder surface 3a extends in the same plane as the positioning element 2 plane comprising the fixture recesses 6 in a pre-bonding state, whereas the bracket holder surface 3a after hinging down is opposite the tooth surface. This can be either on the lingual side or on the labial/buccal side of the teeth.

FIG. 2 shows a bonding device 1 situated above a lower jaw 7 of a patient. The device 1 is adapted for bonding the brackets 4 to the teeth T in the lower jaw 7. However, the device 1 can also be adapted for bonding brackets 4 on teeth T in an upper jaw, or even for bonding brackets to teeth in a lower jaw and an upper jaw at the same time.

In FIG. 3 is shown that the bonding device 1 is placed on the teeth T of the patient. The fixture recesses 6 are receiving the teeth T of the patient, thereby fixating the bonding device 1 to prevent it from sliding relative to the teeth T. The bracket holders 3 comprising brackets 4 are brought towards the buccal (Bu)/labial (La) side of the teeth T. The bonding device 1 can also be adapted to bring the bracket 4 towards an inner surface of the tooth to bond the bracket 4 on the lingual surface of the tooth. Therefore, the positioning element 2 can have a shape like a horseshoe. It is even possible to bond brackets on both sides at the same time. The positioning element 2 then comprises bracket holders 3 on two edges.

In FIG. 4 is shown that the bonding device 1 further comprises a fixation element 7 for fixating the bracket holders and thus the brackets 4 after these are bonded to the tooth surfaces. Before putting the positioning element 2 with the bracket holders 3 on the teeth T, adhesive or bonding cement is applied to the brackets 4 that are releaseably mounted on the bracket holders 3. The fixation element 7 fixates the bracket holders 3 and, consequently, fixates the brackets 4 on the teeth in order to enable the bonding cement to harden. The fixation element 7 can be a fixation ring, a spring, a rubber, a band or the like.

FIG. 5 shows a top view of the bonding device 1, the device being in fixed position on the teeth T. In FIG. 5a a cross section shows the bracket holder 3 hingedly brought towards the tooth surface 5. The bracket 4 is bonded to the tooth surface 5 with aid of a bonding cement. Any suitable dental or orthodontic adhesive is used to hold the bracket in place.

It can be clearly seen that the fixture recesses 6 are receiving the teeth in order to position the positioning element 2 exactly on the right way on the patient's set of teeth. In cross section 5b, the bracket holder 3 is in its initial position, holding the bracket 4 that has to be bonded by the orthodontist. Because the bracket holder 3 can only be moved according to one particular movement, also another person than the orthodontist, for instance an assistant, is able to bond the bracket 4 to the correct position.

FIG. 6 shows a detail of a perspective view of the bonding device 1.

The bracket holders 3 are hinged downwardly to face the buccal (Bu)/labial (La) surfaces of the teeth. The brackets 4 are releaseably mounted on the bracket holders 3 with aid of bracket mounts 8. The bracket mounts 8 are adapted to cooperate with an arch wire cavity 9 in the bracket 4. The bracket mounts 8 comprise a ridge 10 that is receivable in the arch wire cavity 9 for fixing the bracket 4 in a direction parallel of a tooth axis B extending from a root of a tooth to an incisal/occlusal edge of a tooth. Preferably, the ridge 10 comprises at least one end stop for fixing the bracket in a direction parallel to the arch wire cavity 9 (not shown).

FIG. 7-16 show another embodiment of a bonding device according to the invention. Clearly visible are the bracket holders 23 and the positioning element 22. The positioning element 22 is provided with fixture recesses 26 in which the teeth fit for providing a stable, fixed position of the positioning element 22 relative to the teeth. In this embodiment the bracket holders 23 have two stable positions relative to the positioning element 22. One of the stable positions is an end position in which the bracket holder 23 has to be positioned for positioning the bracket 24 in the desired position relative to the respective tooth T. An advantage obtained with this embodiment is that the bracket 24 can be kept at a small distance from the tooth surface 25 so that direct contact between the bracket 24 and the surface of the tooth T is prevented. Thus it is assured that under the entire bracket 24 a bonding layer is present. This is important to obtain a good bonding between the bracket 24 and the tooth surface 25.

With layer manufacturing techniques it is now possible to form the entire device, i.e. positioning element 22 with bracket holders 23 simultaneously. The bracket holders 23 can be provided with a real hinge shaft 25 which is mounted in a hinge shaft mounting 26. The hinge shaft 25 can be given a non-circular cross section, e.g. a square cross section, preferably with rounded edges while the shaft mounting 26 in the positioning element 22 can have a square cross section with a slightly larger size, so that the hinge shaft 25 can assume at least two stable positions, i.e. a start position shown in FIGS. 8-13 and an end position shown in FIGS. 14 and 15. The advantage of a bonding device in which the bracket holders 23 have two, or at least a limited number of stable positions is that no special measures have to be taken to keep the bracket holders 23 in the end position. Once a bracket holder 23 has assumed the stable end position it will stay there until the orthodontist or his assistant has verified that the bonding material is hardened and bracket is fixed on the tooth T. After that, the bracket can be disconnected from the bracket holder 23 and the bracket holder 23 can be brought back into the start position.

In the embodiment with the hinge shaft 25 having the two stable positions and which has been made with layer manufacturing techniques, the space around the hinge shaft 25 in the hinge shaft mounting 26 can be filled during the layer manufacturing process with a support material which is wax like. The support material removes undesired play between the hinge shaft and the hinge shaft mounting. With the modern layer manufacturing techniques the entire device can be made in 2.5 minutes.

The bracket holder 23 may be provided with a abutment element 28, 30, 31 for defining an end position of the bracket holder 23 in which the bracket holder 23 has to be positioned for positioning the bracket in the desired position relative to the respective tooth T.

The abutment member 30, 31 can abut against the tooth T. Such abutment member 30, 31 are clearly visible in FIGS. 10, 14 and 15. These abutment members provide a very direct positional relation between the bracket holder 23 and the tooth T in the end position. In addition or alternatively the abutment member 28 can also be a side of the bracket holder 23 which abuts against a side 27 of the positioning element 22. Such abutment member 28 and side 27 are indicated in FIG. 12.

FIG. 16 shows a diagram representing a method for bonding brackets on teeth. The method comprises several steps. In step S1 data of the patient's set of teeth T are collected. After a dental impression of the teeth and the surrounding soft tissues is made, the negative impression is scanned with a scanner. The scanner functions to gather an array of data points from the teeth impression. The computer generates an image of a virtual model by inverting the scanned impression. The image can also be generated by making an inter-oral digital scan, by making a clinical CT-scan or by scanning a plaster or plastic model of the patient's teeth.

Step S2 represents the virtual placement of the brackets. Therefore, the orthodontist can make a virtual setup of the teeth by manipulating the virtual model of the teeth by moving the individual teeth to a desired position, i.e. the position after correcting the malocclusion of the teeth. The orthodontist determines the best position for bonding a bracket for each individual tooth. The determination of the best position can also be based on the virtual model without making a virtual setup.

The dependent data are then converted in step S3 to manufacturing data, comprising dimensions of the positioning element 2, dimensions and positions of the fixture recesses 6, the bracket holders 3 and the bracket mounts 8.

In step S4 the bonding device 1 is manufactured, for example by means of milling or layer manufacturing technique based on the manufacturing data. When using a milling apparatus, preferably a polymeric material is used. The material is milled on one side, creating the positioning element with the fixture recesses and the bracket holders with the bracket mounts. Then the positioning element 2 is turned and the milling apparatus creates the film hinges 2a of the bracket holders 3.

When the bonding device 1 is created, the brackets 4 are releaseably mounted on the bracket mounts 8 in step S5, the arch wire cavity 9 in the bracket 4 receiving a ridge 10. The brackets 4 can be standard brackets or special adapted brackets. It is also possible that before mounting the brackets 4 on the bracket mounts 8, an arch wire is placed in the arch wire cavity 9 of the bracket 4. Especially when bonding teeth on the lingual surface of a tooth, this can be favourable because of the lack of working space.

In step S6 a bonding cement is applied on the bracket sides that will engage the teeth surfaces.

Thereafter, the bonding device is placed in the patient's oral cavity in step S7, the positioning element 2 fitting on the teeth with aid of the fixture recesses 6 that receive the occlusal/incisal surfaces of the teeth.

Step S8 represents the actual bonding of the brackets. The bracket holders 3 with the brackets 4 are hinged around a hinge axis A one by one to connect the bracket 4 to the tooth surface. The bracket holders 3 are brought towards the teeth surfaces to bring the bracket in the predetermined bonding position. Then the bracket holder with the bracket is pushed against the tooth, whereby the bonding cement is contacting the tooth surface. This can be easily done with one finger or a special device.

In step S9 a fixture element is placed on the bracket holders 3 for fixating the bracket holders 3 and consequently the brackets 4 while the bonding cement is hardening. The orthodontist does not have to press every single bracket 4 till it is tightly stuck.

Finally, the bracket holders 3 are removed from the brackets 4 and hinged back to the initial position (Step S10) and the bonding device 1 is removed from the teeth and out of the oral cavity. The bonding device 1 can be reused for instance when a bracket falls of the tooth surface. The single bracket is placed on the corresponding bracket holder, bonding cement is applied, the bracket holder is placed on the patient's teeth and the single bracket holder is moved to connect the bracket to the tooth surface again.

Although illustrative embodiments of the present invention have been described in greater detail with reference to the accompanying drawings, it is to be understood that the invention is not limited to these embodiments. Various changes or modifications may be effected by one skilled in the art without departing from the scope or the spirit of the invention as defined in the claims. For example, the positioning element can be divided in parts and fit on the teeth one by one to bond the brackets that are mounted on the bracket holders of the individual positioning element parts. It is also possible to provide segments comprising at least one or a limited number of bracket holders, e.g. a front segment or a side segment. It is also possible that not for every adjacent tooth a bracket holder is present on the bonding device but that between every two neighbouring bracket holders a bracket holder for the intermediate tooth is missing. In that manner more space between the bracket holders is provided so that the orthodontist has more space for e.g. removing excess bonding material from the teeth. In such a case at least two bonding devices are necessary per upper or per lower jaw.

Also different manufacturing apparatuses can be used to manufacture the bonding device.

1. A bonding device for bonding orthodontic brackets on teeth, wherein said device comprising
a positioning element;
at least one bracket holder hingedly connected to said positioning element to move relative to said positioning element;
a bracket releaseably mountable on each of said at least one bracket holder; and
surfaces on said positioning element that fit on a set of teeth on both the upper jaw and lower jaw simultaneously in a determined position.

2. (canceled)

3. The device of claim 1 wherein said surfaces on said positioning element include:
fixture recesses for receiving teeth.

4. The device of claim 1, wherein said surfaces on said positioning element include:
fixture recesses that fit on at least one of the surfaces of the teeth being occlusal/incisal surfaces, lingual surfaces or buccal/labial surfaces of the teeth or a combination of said surfaces.

5. (canceled)

6. The bonding device of claim 1 wherein said at least one bracket holder includes:
hinges that mount each of said at least one bracket holder to said positioning element so that each of said at least one bracket holder are is movable towards an outer surface of a tooth to bond each of said at least one bracket on the buccal or labial surface of said tooth and/or towards an inner surface of the tooth to bond each of said brackets on the lingual surface of said tooth.

7. (canceled)

8. (canceled)

9. (canceled)

10. (canceled)

11. The bonding device of claim 1 wherein said device further comprises:
a fixation element for fixating each of said at least one bracket holders with brackets applied with bonding cement against the surface of a tooth until the bonding cement is hardened.

12. (canceled)

13. (canceled)

14. (canceled)

15. (canceled)

16. (canceled)

17. (canceled)

18. (canceled)

19. The bonding device of claim 1 wherein said device is manufactured with aid of milling or layer manufacturing technique.

20. The device of claim 1 wherein said device further includes:
an abutment element for defining an end position of each of said at least one bracket holder in which each of said at least one bracket holder has to be positioned for positioning each of said at least one bracket in the desired position relative to the respective tooth.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. A bonding device for bonding orthodontic brackets on teeth wherein said device comprising
a positioning element for fitting on a set of teeth in a determined position;
at least one bracket holder hingedly connected to said positioning element for movement relative to said positioning element;
a bracket releaseably mountable on said bracket holder; and
an abutment element on each of said at least one bracket holder for defining an end position of said at least one bracket holder a desired position relative to a respective tooth.

51. The bonding device of claim 50, wherein said positioning element includes:
fixture recesses for receiving teeth.

52. The bonding device of claim 50, wherein said positioning element includes:
fixture recesses that fit on at least one of the following surfaces of the teeth: occlusal/incisal surfaces, lingual surfaces or buccal/labial surfaces of the teeth or a combination of said surfaces.

53. The bonding device of claim 50 wherein the device includes:
surfaces on said positioning element that fit on a set of teeth on both the upper jaw and lower jaw simultaneously in a determined position

54. The bonding device of claim 50 wherein said device includes:
a mounting mechanism for mounting said at least one bracket holder to said position element so that said at least one bracket holder is movable towards an outer surface of a tooth to bond said bracket on the buccal or labial surface of the tooth and towards an inner surface of the tooth to bond said bracket on the lingual surface of the tooth.

55. A bonding device of claim 50 wherein said device further comprises
a fixation element for fixating said at least one bracket holders in position with said bracket with bonding cement against a tooth until the bonding cement is hardened.

56. A bonding device of claim 50 wherein said device is manufactured with aid of milling or layer manufacturing technique.

57. A method for manufacturing a bonding device where said bonding device has a positioning element, at least one bracket holder hingeably mounted to said positioning element, and a bracket releaseably mounted on each of said at least one bracket holder, wherein said method comprises the steps of:
providing a virtual model of a set of teeth;
determining a bonding position on a tooth surface of said at least one bracket;
converting the bracket bonding position into manufacturing data;
operating manufacturing in accordance to said manufacturing data to manufacture said positioning element and said at least one bracket holder as an integral unit.

58. The method of claim 57 wherein said step of providing a virtual model of a set of teeth includes:
providing said virtual model of a set of teeth by scanning a negative impression of teeth; and
converting said negative impression into a positive image.

59. The method of claim 57 wherein said step of providing a virtual model of a set of teeth includes:
providing said virtual model from an inter-oral digital scan.

60. The method of claim 57 wherein said step of determining a bonding position includes:
making a virtual setup of the teeth;
indicating the desired position of the brackets on the virtual setup of the teeth; and
placing the virtual teeth back in the initial position.

61. The method of claim 57 wherein said step of determining a bonding position includes:
creating fixture recesses on at least one surface of the positioning element that receive teeth.

62. The method of claim 57 wherein said step of determining a bonding position includes:
creating fixture recesses on at least one surface of the positioning element that receive teeth; and
said at least one surface selected from one of the following surfaces of the teeth: occlusal/incisal surfaces, lingual surfaces or buccal/labial surfaces or a combination of these surfaces.
